(19) United States
(12) Patent Application Publication
(10) Pub. No.: US 2005/0204199 A1
(43) Pub. Date: Sep. 15, 2005

(54) Automatic crash recovery in computer operating systems

(75) Inventors: Richard E. Harper, Chapel Hill, NC (US); Jason D. LaVoie, Mahopac, NY (US); Charles O. Schulz, Ridgefield, CT (US)

Correspondence Address: FERENCE & ASSOCIATES, 409 BROAD STREET, PITTSBURGH, PA, 15143, US

(73) Assignee: IBM Corporation, Armonk, NY (US)

(21) Appl. No.: 10/788,958

(22) Filed: Feb. 28, 2004

(51) Int. Cl. G06F 11/00

(52) U.S. Cl. 714/38

(57) ABSTRACT

Methods and arrangements for providing automatic recovery from operating system faults. Carried out are automatic steps for detecting a system fault, analyzing the system fault, determining a cause of the system fault; determining a solution, and applying a solution.

### FIELD OF THE INVENTION

The present invention relates to operating systems and, more specifically, to the updating of certain components in the event of an operating system failure.

### BACKGROUND OF THE INVENTION

Many operating systems lack stability, which is largely attributed to faulty device drivers (also known as modules). Though the kernels of these operating systems have been thoroughly tested and have been around a long time, device drivers are created and changed regularly. Problems have long been observed in connection with machines that “crash” when device drivers cause faults. Particularly, device drivers typically do not undergo rigorous testing. However, it is recognized that if a faulty device driver is not critical to machine operation, there is no reason why this device driver should “take down” the entire machine, thereby resulting in lost data and downtime.

“Enterprise Problem Solver” (Softlanding Systems; http://www.softlandingeurope.com/eps/index.htm) monitors applications and sends e-mail to operators, administrators, and/or the help desk in the event there is an error or problem in an application. In the event of a system crash, The “Alexander System Protection Kit” (Alexander LAN Inc.; http://www.alexander.com/images/SPKWin5-DataSheet.pdf.) will perform some analysis as to the cause of the crash and e-mail the result of the analysis to the operators, administrators and/or the help desk. For analysis, the Alexander System Protection Kit maintains the state of the system by running in the background and consuming machine resources.

The System Manager and Service Director for the IBM “iSeries” (IBM Corporation; IBM System Manager and Services director; http://www-1.ibm.support.docview.wss?uid=nas 17ed37fd60d3e1d3b8625692900678e8c7) is a service that, when a system fault occurs, log a problem with the IBM support center and e-mail the system administrator. The support center, upon receiving the notification of the fault, can automatically notify an IBM service engineer.

There are many tools available for various platforms used to analyze system crashes. “WinDbg” for Windows XP contains features to “guess” at what caused the crash. “Ksymoops”, “dumpchk”, and “LCrash/Crash” for Linux allow for manual in-depth system crash analysis.

Many applications including Windows 2000/XP allow bulk updates of fixes. None of these applications perform single updates based on the information from a particular system's fault.

All of the conventional techniques referred to above perform limited functions, but none are in a position to automatically undertake an entire “cycle” of functions in response to a system crash. Accordingly, a need has been recognized in connection with providing an arrangement that readily offers such a “cycle” in its entirety.

### SUMMARY OF THE INVENTION

There is broadly contemplated herein automatic crash recovery for operating systems. When an operating system crash is detected, the faulty device drivers are identified, unloaded, repaired, and then restarted. For repairs to take place, a mapping of symptoms to fixes must be maintained either on the local machine or one or more remote servers. After a potential fix for crash is identified, it is downloaded and installed. After the installation of the repaired or replaced driver, the driver is restarted. Other steps, such as determining the possibility of corruption, are also contemplated.

In summary, one aspect of the invention provides a method of providing automatic recovery from operating system faults, the method comprising the steps of: detecting a system fault; analyzing the system fault; determining a cause of the system fault; determining a solution; and applying a solution.

Another aspect of the invention provides an apparatus for providing automatic recovery from operating system faults, the apparatus comprising: an arrangement for detecting a system fault; an arrangement for analyzing the system fault; an arrangement for determining a cause of the system fault; an arrangement for determining a solution; and an arrangement for applying a solution.

Furthermore, an additional aspect of the invention provides a program storage device readable by machine, tangibly embodying a program of instructions executable by the machine to perform method steps for providing automatic recovery from operating system faults, the method comprising the steps of: detecting a system fault; analyzing the system fault; determining a cause of the system fault; determining a solution; and applying a solution.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a block diagram illustrating a runtime environment.

FIG. 2 is a block diagram illustrating another runtime environment.

FIG. 3 is a timeline showing a sequence of steps.

FIG. 4 is a block diagram showing the relationship of a crashed computer and a service server on a network.

FIG. 5 is a block diagram showing the relationship of a crashed computer and a download server on a network.

### DESCRIPTION OF THE PREFERRED EMBODIMENTS

Crashes in computer operating systems are not only a nuisance, but they cause costly downtime and lost data. Broadly contemplated herein are methods and arrangements for recovering from a crash in such a way that downtime and lost data is reduced dramatically. Several studies have shown the instability in operating systems comes from device drivers and not the operating system kernel itself. Kernels tend to have long lives while device drivers come and go with each new device on the market.

Some general definitions will provide further assistance with the discussion herein.

In an “operating system crash”, the sudden failure of the operating system results in a “frozen” screen showing some information or an automatic reboot. An operating system crash is also known as a “system crash”, “Blue Screen of Death” (named after the information screen on Microsoft Windows”, and “Kernel Panic” (or just “Panic” for short).

A “kernel” is essentially the core of an operating system which handles main functions. It contains the native kernel environment that implements services exposed to applications in user space and provides services for writing kernel extensions. The term “native” can be used as a modifier to refer to a particular kernel environment. AIX, Linux, and Windows 2000 all have distinct native kernel environments; they are distinct because they each have a specific set of application program interfaces (API) for writing subsystems (such as network adapter drivers, video drivers, or kernel extensions).

“Device drivers” are loadable kernel-mode modules that interface between the kernel and the relevant hardware (see Solomon, David and Mark Russinovich, Inside Microsoft Windows 2000 3rd ed., Redmond: Microsoft Press, 2000). Some examples include drivers for CD ROM's and network cards.

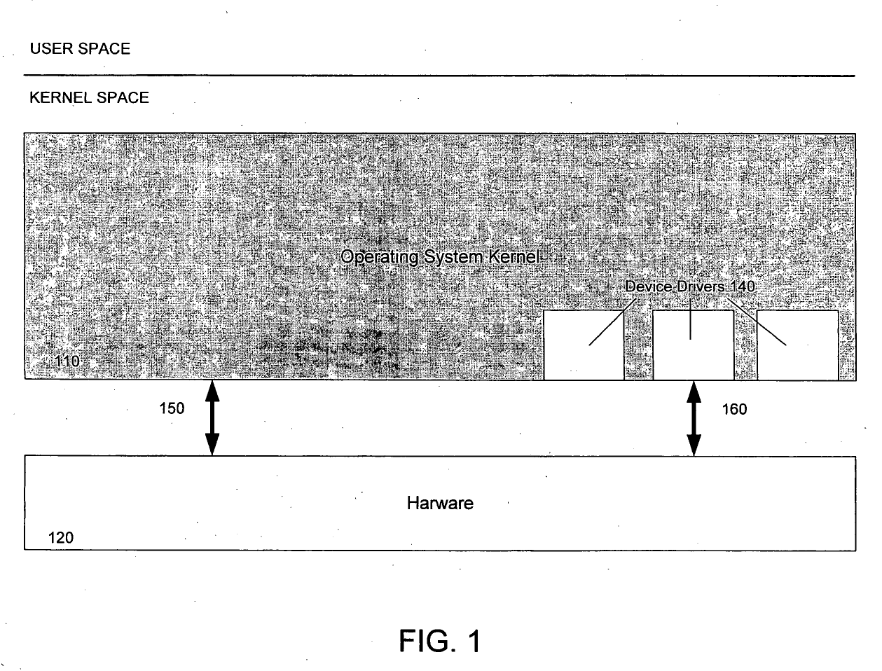

FIG. 1 shows a typical layout of an operating system. The Operating System Kernel 110 operates in privileged mode in the kernel address space of the host computer. Device Drivers 140 are either compiled into the kernel 110 or are loaded by the kernel 110 into the kernel address space. These device drivers are allowed to run in the same context (i.e. privileged mode) as the kernel 110. The kernel 110 and the device drivers 140 communicate (at 150, 160, respectively) with the hardware 120 of the computer.

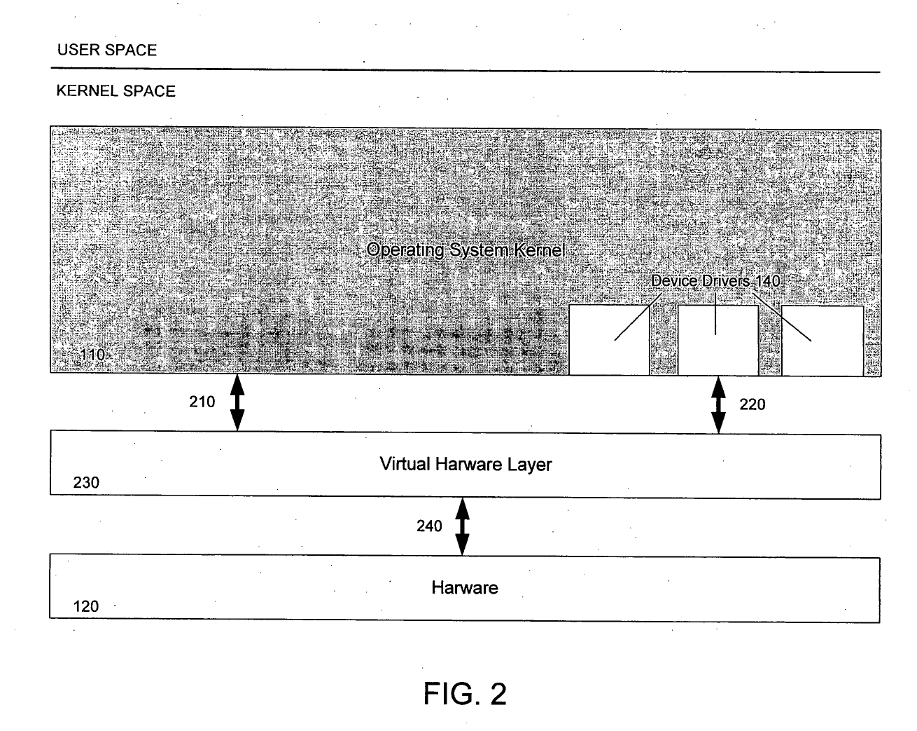

Some operating systems make use of a virtual “view” of the hardware, as seen in FIG. 2. The kernel 110 and device drivers 140 thus communicate (at 210, 220) with a Virtual Hardware Layer 230 which, in turn, communicates (at 240) directly with the hardware 120. Usually, the virtual hardware layer 230 is part of the operating system.

In both cases (FIGS. 1 and 2), although the device drivers 140 run in the context of the kernel 110, they are not necessarily a part of the kernel. Typically, device drivers 140 are written by several different hardware vendors using disparate levels of quality management and communicate with the kernel 110 using a well known Application Program Interface (API).

When device drivers 140 encounter a fault, typically, the kernel 110 considers this to be a serious error because the device drivers 140 run in a privileged context. However, analysis has shown that a majority of device driver faults are not serious; this means that the operating system can continue to function with no problem (except for possibly encountering the fault again). If the computer can continue to function with no problem, then there is really no need to force a reboot of the computer, which is the typically the only recourse. However, if the fault is considered to be serious, that is, if it caused corruption to the kernel or state of the kernel or may be malicious code, then the computer should not be allowed to continue to operate without a reboot.

In accordance with at least one preferred embodiment of the present invention, the method for automatic crash recovery in computer operating systems supplies steps in recovering, without reboot, from a non-serious (e.g. non-corrupting) system crash. In an exemplary embodiment of this method, these steps are performed after a crash has occurred. This can be done by intercepting the panic function in Linux or the KeBugCheck in Windows NT/2000/XP. Since crash recovery is done after the crash has occurred, no system resources are consumed during normal operation of the computer.

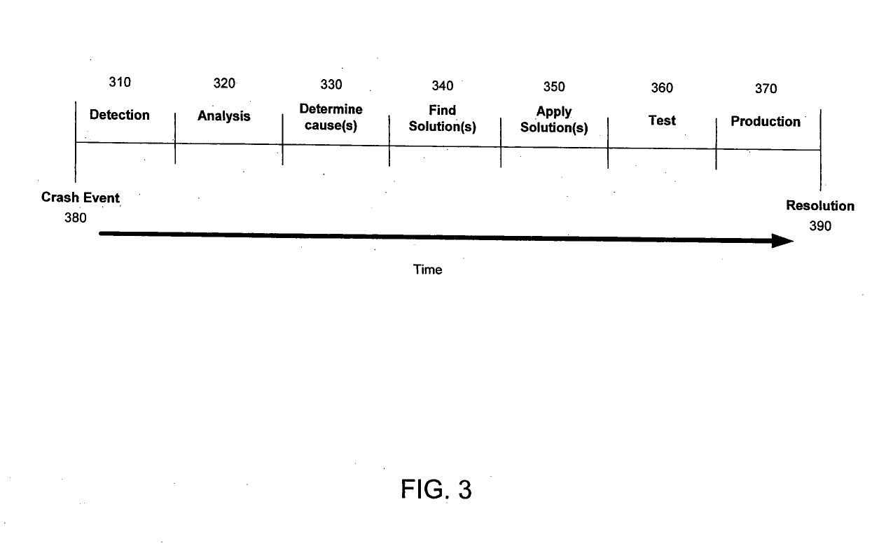

An exemplary embodiment of the method for automatic crash recovery is shown in FIG. 3. The steps are performed, not necessarily synchronously, from left to right, progressing with time. The crash event 380, in an exemplary embodiment, relates to the aforementioned interception of the crash function(s). In this case, step 1, Detection, 310 coincides with the Crash Event 380 itself. Typically, at this time, all programs in the process of running are suspended, and no user interaction can take place.

Analysis 320 involves probing the kernel 110, device drivers 140, and the hardware to determine the state of the machine at the time of the crash event 380. In an exemplary embodiment, the components of the kernel that will be probed include the kernel stack, process stacks, page tables, and the device drivers loaded at the time of crash event. In an exemplary embodiment, the components of the hardware that will be probed include main memory, hardware registers (e.g. the instruction register), and the state and contents of the disk. States of the various loaded device drivers 140 will also be inspected.

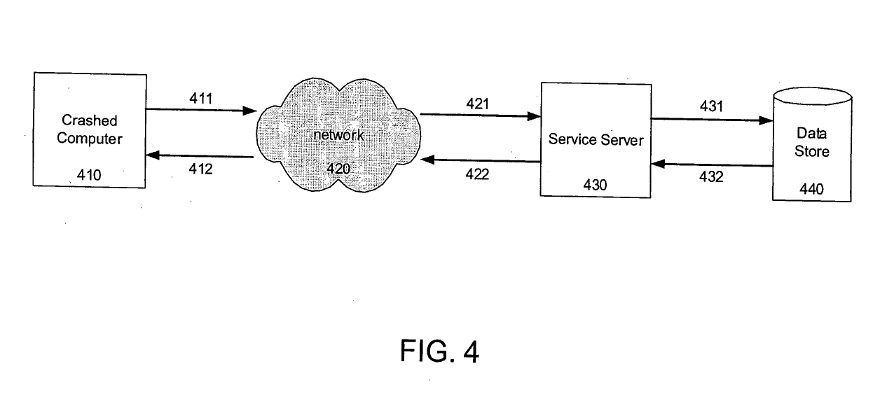

After as much data as possible can be gathered from the crashed machine, the cause of the crash is determined 330. In an exemplary embodiment of this method, probable causes of the crash could be a fault in the kernel 110 itself (this includes the virtual hardware layer 230, if any), one or more device drivers 140, or a hardware 120 component. If the kernel 110 is determined 330 to be the cause of the crash event 380, but the kernel 110 does not allow runtime replacement of components, then the standard manual crash recovery procedure for the kernel 110 is followed instead of continuing with this method. If the hardware 120 is determined 330 to be the cause of the crash event 380, then the standard manual crash recovery procedure for the kernel 110 is followed instead of continuing with this method. Typically, a manual crash recovery procedure involves rebooting and performing lengthy manual analysis. After the analysis, an updated kernel or new hardware might be installed. In an exemplary embodiment of this method, to determine the cause 330 of the fault, an external server 430 may be consulted (411, 421) as seen in FIG. 4. This server may reference (431) a data store 440 containing mappings between state and symptoms to probable causes. It is possible this data store 440 could be located on the Crashed Computer 410, in which case, an external server 430 may not be consulted. The data store 440 could be a flat file, a data base, or any other storage mechanism. In an exemplary embodiment, the service server 430 is connected to the crashed machine via a network 420. This network could be the Internet, intranet, or other type of interconnect between computers. A response 412, 422 is sent back to the Crashed Computer 410 after the Service Server 430 processes the information it received 432 from the Data Store 440.

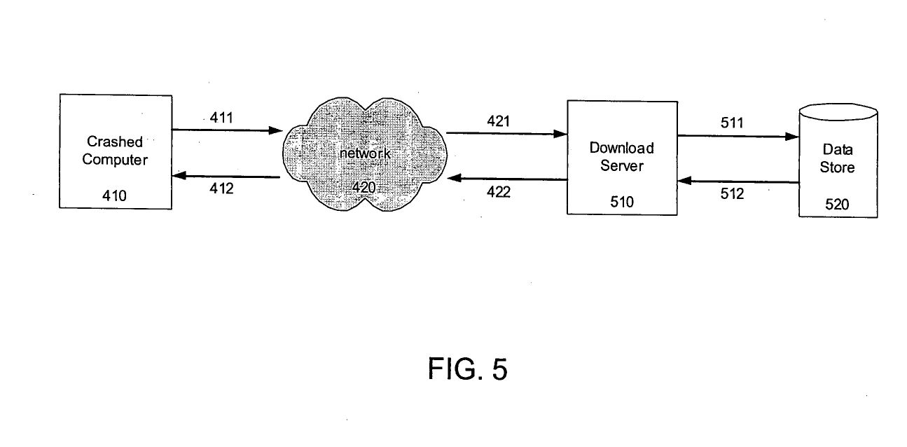

After determining the cause 330 of the fault, one or more solutions or fixes should be obtained 340. In an exemplary embodiment of the present invention, the solutions or fixes can be downloaded 411, 412 from a remote Download Server 510 as seen in FIG. 5. The remote Download Server 510 could be hosted by the device driver vendor, the machine vendor, or other solutions provider. In an exemplary embodiment, the Download Server 510 is connected via a network 420 and maintains solutions and fixes in a Data Store 520 that responds 512 to requests 511 for solutions or information pertaining to the solutions. The solutions or fixes could be any combination of instructions on changing the settings of a faulty device driver (e.g. a script), an update to a faulty device driver, or a replacement of a faulty device driver. A cache of fixes could be located on the faulty machine. The data store 520 could be a flat file, a data base, or any other storage mechanism.

Once the download of one or more solutions 340 to the fault is complete or the solution is located in a cache of fixes on the Crashed Computer 410, then the solutions are applied or installed 350. If a fix is a set of instructions or script that changes the configuration of the Crashed Machine 410, then the script is executed. If a solution to the fault is an update to a faulty device driver, then the update can be executed over the current version of the driver. If the solution is a replacement device driver, then the existing faulty device driver is optionally uninstalled, and the new device driver is installed. Other variations of installing fixes or patches may also exist. If more than one solution exists for a given fault, then the order in which to apply those solutions will be specified in the solutions, or as a set of instructions provided with the solutions.

The newly applied solutions are then tested 360. In an exemplary embodiment of this method, the testing step 360 entails removing the Crashed Computer 410 from the suspended state that the kernel entered during the crash event 280. The computer is allowed to continue to run; however, the new device driver may be monitored for a short period of time to ensure proper operation. Additionally, during the solution acquisition stage 340 one or more test programs may be acquired. If this is the case, the test programs are executed before returning the machine back over the user and/or user programs. If a test program reports a negative result, then the fault resolution method returns to the analysis stage 320. If a test program reports a positive result, then the machine is returned to production 370. The Crashed Computer 410 may contact the service server 430 to report the successful resolution of the crash or other information pertaining to the solution.

In an exemplary embodiment of the present invention, returning to production (370) can involve providing all computing resources back to the user(s) and allowing all suspended programs to continue to run as if the interruption never occurred. At this time the fault has been resolved (390), and no final steps are required.

In an exemplary embodiment of the present invention, not all faults necessarily have a fix or solution. Supplied configuration information can be used to determine if a device, therefore its respective device driver(s), are not required for proper continued execution of the computer. An example of this might be a CD ROM device driver for a machine with infrequent CD ROM use. If such is the case for a faulty device driver, it is unloaded from kernel memory space and not restarted. If such a device driver cannot be unloaded due to corruption, then it is quarantined. Quarantining a device driver means it remains in kernel memory, but it will no longer be able to send or receive messages to the kernel 110, thereby, rendering it disabled. This allows the faulty device driver to be repaired during a planned outage.

In an exemplary embodiment of the present invention, the level of corruption caused by faulty device drivers can be determined during the analysis step 320. The level of corruption can be defined as unwanted changes to any facet of the data on the computer (e.g. data in memory or on the hard drive). If a high enough level of corruption is detected, then normal crash recovery procedures will be resumed. The exemplary embodiment recognizes that corruption may be caused by one or more device drivers, although a different, non-faulty device driver may crash.

In an exemplary embodiment of the present invention, log messages, electronic messages (e.g. e-mail), or on-screen error messages can be used to communicate with the operator or administrator of the computer. Also, in an exemplary embodiment of the present invention, a forced reboot could optionally be made to occur between any of the steps in the method, if indeed the arrangements for performing the method are configured as such.

Generally, there are broadly contemplated herein methods and arrangements for providing automatic recovery from operating system faults, involving the steps of: detecting a system fault; analyzing the system fault; determining a cause of the system fault; determining a solution; and applying a solution. Further steps may involve providing a resolution test and returning to production.

At least one of the above-recited steps might not require any work.

The detecting step may involve at least one of: an operating system call to a halting routine; and an exception or error associated with at least one of: an operating system, middleware, firmware and Licensed Internal Code. It may involve an abnormal termination of a driver or application, a hypervisor observation of unusual behavior from a guest operating system, or an interception of a call to an operating system halting routine or exception handler.

Preferably, the detecting step may involve the automatic inspection of at least one aspect relating to the operating system, such as one or more of the following: main memory; a kernel stack; process stacks; a state of all running threads; an amount of pageable memory used; an amount of pageable memory free for use; an amount of total pageable memory in the system; an amount of total pageable memory available to the operating system kernel; an amount of non-pageable memory used; an amount of Non-pageable memory free for use; an amount of total non-pageable memory in the system; an amount of total non-pageable memory available to the operating system kernel; a number of system page table entries used; a number of system page table entries available for use; an amount of virtual memory allocated to a system page table; a size of a system cache; a size of a page cache; a size of a file cache; an amount of space available in a system cache; an amount of space available in a page cache; an amount of space available in a file cache; a size of a system working set; a number of system buffers available; page sizes; a number of network connections established; utilization of one or more central processing units; a number of threads allocated; a percentage of time spent in a kernel; a number of system interrupts per unit time; a number of page faults per unit time; a number of page faults in a system cache per unit time; a number of paged pool allocations per unit time; a number of non-paged pool allocations per unit time; a length of look-aside lists; a number of open file descriptors; an amount of free space on a disk or disks; a percentage of time spent at interrupt level; a number of device drivers that are loaded; status of loaded device drivers; a number of outstanding I/O requests for device drivers; a state of devices attached to the system.

The step of automatically inspecting may involve determining a degree of memory corruption, and manual fault resolution may be prompted if memory corruption is detected. The automatic inspection may be performed via software.

The aforementioned step of “determining a cause” preferably involves identifying at least one faulty component. The aforementioned “analyzing” step could provide input into the step of determining a cause, as could external information.

The aforementioned step of “applying a solution” may comprise effecting one or more changes or updates in at least one of: device driver software, operating system code, and firmware. This could also involve the deactivation of faulty software.

The aforementioned step of “providing a resolution test” can involve monitoring a new component during a trial period, which could be over a finite period of time. The status of the new component could be reported subsequent to the trial period.

Upon determination of a negative status of the new component, at least one of the following steps is repeated: detecting a system fault; analyzing the system fault; determining a cause of the system fault; determining a solution; applying a solution; and providing a resolution test.

It is to be understood that the present invention, in accordance with at least one presently preferred embodiment, includes arrangements for detecting a system fault, analyzing the system fault, determining a cause of the system fault, determining a solution; and applying a solution. Together, these elements may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A method of providing automatic recovery from operating system faults, said method comprising the steps of:
detecting a system fault;
analyzing the system fault;
determining a cause of the system fault;
determining a solution; and
applying a solution.

2. The method according to claim 1, further comprising the steps of:
providing a resolution test; and
returning to production.

3. The method according to claim 1, wherein at least one of the recited steps does not require any work.

4. The method according to claim 2, wherein at least one of the recited steps does not require any work.

5. The method according to claim 1, wherein said detecting step comprises at least one of:
an operating system call to a halting routine; and
an exception or error associated with at least one of: an operating system, middleware, firmware and Licensed Internal Code.

6. The method according to claim 1, wherein said detecting step comprises an abnormal termination of a driver or application.

7. The method according to claim 1, wherein said detecting step comprises a hypervisor observation of unusual behavior from a guest operating system.

8. The method according to claim 1, wherein said detecting step comprises an interception of a call to an operating system halting routine or exception handler.

9. The method according to claim 1, wherein said detecting step comprises automatically inspecting at least one aspect relating to the operating system.

10. The method according to claim 9, wherein said detecting step comprises automatically inspecting at least one of: main memory; a kernel stack; process stacks; a state of all running threads; an amount of pageable memory used; an amount of pageable memory free for use; an amount of total pageable memory in the system; an amount of total pageable memory available to the operating system kernel; an amount of non-pageable memory used; an amount of Non-pageable memory free for use; an amount of total non-pageable memory in the system; an amount of total non-pageable memory available to the operating system kernel; a number of system page table entries used; a number of system page table entries available for use; an amount of virtual memory allocated to a system page table; a size of a system cache; a size of a page cache; a size of a file cache; an amount of space available in a system cache; an amount of space available in a page cache; an amount of space available in a file cache; a size of a system working set; a number of system buffers available; page sizes; a number of network connections established; utilization of one or more central processing units; a number of threads allocated; a percentage of time spent in a kernel; a number of system interrupts per unit time; a number of page faults per unit time; a number of page faults in a system cache per unit time; a number of paged pool allocations per unit time; a number of non-paged pool allocations per unit time; a length of look-aside lists; a number of open file descriptors; an amount of free space on a disk or disks; a percentage of time spent at interrupt level; a number of device drivers that are loaded; status of loaded device drivers; a number of outstanding I/O requests for device drivers; a state of devices attached to the system.

11. The method according to claim 9, wherein said step of automatically inspecting comprises determining a degree of memory corruption.

12. The method according to claim 11, wherein manual fault resolution is prompted if memory corruption is detected.

13. The method according to claim 9, wherein said step of automatically inspecting is performed via software.

14. The method according to claim 1, wherein said step of determining a cause comprises identifying at least one faulty component.

15. The method according to claim 14, wherein said analyzing step provides input into said step of determining a cause.

16. The method according to claim 14, wherein external information provides input into said step of determining a cause.

17. The method according to claim 1, wherein said step of applying a solution comprises effecting one or more changes or updates in at least one of: device driver software, operating system code, and firmware.

18. The method according to claim 17, wherein said step of effecting one or more changes or updates comprises deactivating faulty software.

19. The method according to claim 2, wherein said step of providing a resolution test comprises monitoring a new component during a trial period.

20. The method according to claim 19, wherein the trial period is over a finite period of time.

21. The method according to claim 19, wherein the status of the new component is reported subsequent to the trial period.

22. The method according to claim 21, wherein at least one of the following steps is repeated upon determination of a negative status of the new component: detecting a system fault; analyzing the system fault; determining a cause of the system fault; determining a solution; applying a solution; and providing a resolution test.

23. An apparatus for providing automatic recovery from operating system faults, said apparatus comprising:
an arrangement for detecting a system fault;
an arrangement for analyzing the system fault;
an arrangement for determining a cause of the system fault;
an arrangement for determining a solution; and
an arrangement for applying a solution.

24. The apparatus according to claim 23, further comprising:
an arrangement for providing a resolution test; and
an arrangement for returning to production.

25. The apparatus according to claim 23, wherein said detecting arrangement is adapted to provide at least one of:
an operating system call to a halting routine; and
an exception or error associated with at least one of: an operating system, middleware, firmware and Licensed Internal Code.

26. The apparatus according to claim 23, wherein said detecting arrangement is adapted to provide an abnormal termination of a driver or application.

27. The apparatus according to claim 23, wherein said detecting arrangement is adapted to provide a hypervisor observation of unusual behavior from a guest operating system.

28. The apparatus according to claim 23, wherein said detecting arrangement is adapted to provide an interception of a call to an operating system halting routine or exception handler.

29. The apparatus according to claim 23, wherein said detecting arrangement is adapted to automatically inspect at least one aspect relating to the operating system.

30. The apparatus according to claim 29, wherein said detecting arrangement is adapted to automatically inspect at least one of: main memory; a kernel stack; process stacks; a state of all running threads; an amount of pageable memory used; an amount of pageable memory free for use; an amount of total pageable memory in the system; an amount of total pageable memory available to the operating system kernel; an amount of non-pageable memory used; an amount of Non-pageable memory free for use; an amount of total non-pageable memory in the system; an amount of total non-pageable memory available to the operating system kernel; a number of system page table entries used; a number of system page table entries available for use; an amount of virtual memory allocated to a system page table; a size of a system cache; a size of a page cache; a size of a file cache; an amount of space available in a system cache; an amount of space available in a page cache; an amount of space available in a file cache; a size of a system working set; a number of system buffers available; page sizes; a number of network connections established; utilization of one or more central processing units; a number of threads allocated; a percentage of time spent in a kernel; a number of system interrupts per unit time; a number of page faults per unit time; a number of page faults in a system cache per unit time; a number of paged pool allocations per unit time; a number of non-paged pool allocations per unit time; a length of look-aside lists; a number of open file descriptors; an amount of free space on a disk or disks; a percentage of time spent at interrupt level; a number of device drivers that are loaded; status of loaded device drivers; a number of outstanding I/O requests for device drivers; a state of devices attached to the system.

31. The apparatus according to claim 29, wherein said detecting arrangement is adapted to determine a degree of memory corruption.

32. The apparatus according to claim 31, wherein manual fault resolution is prompted if memory corruption is detected.

33. The apparatus according to claim 29, wherein said detecting arrangement is adapted to perform automatic inspecting via software.

34. The apparatus according to claim 23, wherein said arrangement for determining a cause is adapted to identify at least one faulty component.

35. The apparatus according to claim 34, wherein said analyzing arrangement provides input into said arrangement for determining a cause.

36. The apparatus according to claim 34, wherein external information provides input into said arrangement for determining a cause.

37. The apparatus according to claim 23, wherein said arrangement for applying a solution is adapted to effect one or more changes or updates in at least one of: device driver software, operating system code, and firmware.

38. The apparatus according to claim 37, wherein said arrangement for effecting one or more changes or updates is adapted to deactivate faulty software.

39. The apparatus according to claim 24, wherein said arrangement for providing a resolution test comprises monitoring a new component during a trial period.

40. The apparatus according to claim 39, wherein the trial period is over a finite period of time.

41. The apparatus according to claim 39, wherein said arrangement for providing a resolution test is adapted to report the status of the new component subsequent to the trial period.

42. The apparatus according to claim 41, wherein at least one of the following is repeated upon determination of a negative status of the new component: detecting a system fault; analyzing the system fault; determining a cause of the system fault; determining a solution; applying a solution; and providing a resolution test.

43. A program storage device readable by machine, tangibly embodying a program of instructions executable by the machine to perform method steps for providing automatic recovery from operating system faults, said method comprising the steps of:
detecting a system fault;
analyzing the system fault;
determining a cause of the system fault;
determining a solution; and
applying a solution.
